(19) United States
(12) Patent Application Publication
(10) Pub. No.: US 2026/0105292 A1
(43) Pub. Date: Apr. 16, 2026

(54) SYSTEM AND METHOD FOR EFFICIENT FEATURE-CENTRIC ANALOG TO SPIKE ENCODERS

(71) Applicant: INNATERA NANOSYSTEMS B.V., Rijswijk (NL)

(72) Inventor: Amir ZJAJO, Rijswijk (NL)

(21) Appl. No.: 18/997,807

(22) PCT Filed: Jul. 25, 2023
(86) PCT No.: PCT/EP2023/070631

§ 371 Date: Jan. 23, 2025

Related U.S. Application Data
(60) Provisional application No. 63/391,813, filed on Jul. 25, 2022.

(51) Int. Cl. G06N 3/065; G06N 3/049

(52) U.S. Cl. CPC G06N 3/065; G06N 3/049

(57) ABSTRACT

A signal processing circuit for a spiking neural network, comprising an interface for converting an analog input signal to a corresponding spike-time representation of the analog input signal. The interface comprises an analog-to-information (A/information) converter configured to produce a modulated signal which represents one or more features of the analog input signal; a feature detector circuit configured to compare the modulated signal with a reference signal representing a reference feature, and configured to produce an error signal indicating a difference between the modulated signal and the reference signal; a feature extractor circuit, which comprises a locked loop circuit having an input for receiving the error signal and configured to produce an output signal representing an occurrence of one or more of the features represented by the modulated signal; and an encoder circuit, which is configured to encode the output signal into spike trains for input to the spiking neural network.

### TECHNICAL FIELD

This disclosure generally relates to automatic signal recognition techniques, and more particularly, to system and method for energy-efficient feature-centric analog-to-spike encoders, particularly feature-centric analog-to-spike encoders for spiking neural networks.

### BACKGROUND

Sampling is a process of converting a signal (for example, a function of continuous time or space) into a sequence of values (a function of discrete time or space). A sampling rate is the average number of samples obtained in one second of the signal.

A discrete signal can be considered as sparse in a certain representation domain if the number of nonzero values in that domain is much smaller than the total signal length. A common situation in the case of real-world signals is that the number of significant coefficients is small as compared to the number of other components. These coefficients could be neglected or set to zero. In other words, a sparse signal can be efficiently represented using a small number of non-zero elements.

A sparse signal can be accurately represented with a lower sampling rate compared to a non-sparse signal. The Nyquist-Shannon theorem states that the sampling rate for a non-sparse signal should be at least twice the highest frequency component, while for a sparse signal, the sampling rate can be significantly lower due to the concentrated energy in a few coefficients.

In numerous (natural) signals and sensor applications—e.g., visual, acoustic, environmental, medical monitoring systems—due to corruption from noise, interfering signals, or circuit impairments, the signal is not necessarily sparse, and consequently, standard sub-Nyquist sampling techniques might not be applicable. Sub-Nyquist sampling techniques, also known as compressed sensing or compressive sampling, are methods used to acquire and reconstruct signals at sampling rates significantly lower than sampling rates the Nyquist-Shannon theorem prescribes.

In addition, in many of these applications (such as speech recognition applications, gesture detection systems, heart rate monitors, etc.) neither the entire information content of the original signal, nor its full reconstruction is typically of interest. Processing power and data rate is thus wasted on the processing of uninteresting information.

Power costs in signal conditioning, quantization and wireless communication all scale with the data rate. If one wants to design a system with ultralow-power requirements, a new approach to analog/digital system partitioning is demanded with the goal of significant overall reduction in power consumption.

### SUMMARY OF INVENTION

The inventors of the present invention recognized the entire information content of the original signal, nor its full reconstruction is typically of interest, but that for pattern recognition and signal classification applications typically only a specific subset of information extracted from the waveform of the signal is required, referred to herein as the features of the signal. Some examples of features of the waveform are the maximum signal level over a period of time, the number of zero-crossings, et cetera. These features can provide information about other features such as the frequency content, phase, or timing characteristics of the signal.

The present invention aims to sample the signal at its relevant information/feature rate by extracting a specific set of features that are embedded in analog signal waveforms through pulse modulation and feature-centric adaptive filters/locked loop/synchronization techniques, before modulation-matched signal feature encoding and classification is executed. This allows the signal processing to focus exclusively on feature-bearing information and discard irrelevant information as early in the signal processing path as possible, while filtering out/suppressing other irrelevant information or distorting interferers. By discarding irrelevant information early in the signal processing path, overall system energy-efficiency is significantly improved. This implies more intelligent analog signal processing (i.e. analog analytics) emphasizing relevant features and reducing the dimensionality of the waveform through a feature-preserving transformation with the intention of classifying features of an input signal waveform instead of reconstructing the original waveform.

To achieve this, the present invention discloses, according to a first aspect, a signal processing circuit for a spiking neural network, comprising an interface for converting an analog input signal to a corresponding spike-time representation of the analog input signal. The interface may comprise an analog-to-information (A/information) converter, which comprises an input for receiving the analog input signal and which can be configured to produce a modulated signal which represents one or more features of the analog input signal. Secondly, the interface may comprise a feature detector circuit, which can comprise an input for receiving the modulated signal and which may be configured to compare the modulated signal with a reference signal representing a reference feature, and configured to produce an error signal indicating a difference between the modulated signal and the reference signal. Furthermore, the interface may comprise a feature extractor circuit, which comprises a locked loop circuit having an input for receiving the error signal and may be configured to produce an output signal representing an occurrence of one or more of the features represented by the modulated signal. Also, the interface may comprise an encoder circuit, which may have an input for receiving the output signal of the feature extractor and is configured to encode the output signal into spike trains for input to the spiking neural network.

According to an embodiment of the first aspect, the signal processing circuit further may comprise a preprocessing circuit that preprocesses the analog input signal, preferably wherein the preprocessing circuit comprises a low-noise preamplifier, a band-pass filter, and/or a programmable gain (post-)amplifier.

According to an embodiment of the first aspect, the analog input signal may be in voltage representation and may be used as control voltage input to the A/information converter, thus determining the modulation of the analog input signal.

According to an embodiment of the first aspect, the feature may be one or more of i) specific characteristics, such as transient features, steady-state features, ii) specific properties, such as (non)linearity features, statistical features, stationary features, transfer-function features, energy-content and/or based on iii) specific domain features, such as time-, delay-, frequency-, phase-domain features, preferably wherein the A/information converter comprises an analog-to-time converter which converts the analog input signal into a modulated signal which represents certain time-domain features such as delay, frequency and/or phase.

According to an embodiment of the first aspect, the A/information converter may form an analog-to-delay (A/delay) converter, an analog-to-frequency (A/frequency) converter, and/or an analog-to-phase (A/phase) converter;

According to an embodiment of the first aspect, the A/information converter may comprise a voltage-controlled delay line, a voltage-controlled oscillator and/or a multiphase voltage-controlled oscillator that performs at least a part of the modulation of the analog input signal into the modulated signal;

According to an embodiment of the first aspect, the A/delay converter may comprise the voltage-controlled delay line, the A/frequency converter may comprise the voltage-controlled oscillator and the A/phase converter may comprise the multiphase voltage-controlled oscillator.

According to an embodiment of the first aspect, the output signal of the feature extractor circuit may be fed back to the feature detector circuit so as to form a negative feedback loop.

According to an embodiment of the first aspect, the feature extractor circuit may comprise a voltage-controlled oscillator which is driven by the error signal and which creates the output signal of the feature extractor circuit and is part of the locked loop.

According to an embodiment of the first aspect, the locked loop may be a delay-locked loop, a frequency-locked loop or a phase-locked loop.

According to an embodiment of the first aspect, the feature extractor circuit furthermore may comprise a filter, preferably an adaptive filter, that stops the part of the error signal if it is not in the locking range of the locked loop, but that lets through part of the error signal which is in the locking range of the locked loop.

According to an embodiment of the first aspect, the encoder circuit may use rate-based or temporal, spike-based encoding as the encoding scheme.

According to an embodiment of the first aspect, the feature extractor circuit may be a part of a set of parallel feature extractors circuits, and wherein the signal processing circuit furthermore comprises a channel selector unit which may be adaptive in such a way that a subset of features most beneficial under specific operating conditions at any given moment in time are being extracted, so that the one or more feature extractor circuits corresponding to the subset of features of interest can be adaptively selected, and information on those features are extracted from the signal from the A/information converter by the parallel feature extractor circuits.

According to an embodiment of the first aspect, feature extraction performed by the feature extractor circuit may be configurable through the specific circuits parameters and/or system control parameters, preferably the configurable parameters include one or more of gain, linearity, bandwidth, feed-forward and feed-back, coarse/fine selectivity, ATC control, feedback control, calibration, timing, delay, sampling/sub-sampling mode selection.

According to an embodiment of the first aspect, at run time, an application/context/condition detection block may determine the current operating context and from the current operating context the optimal analog feature set to be extracted, preferably wherein a feedback loop dynamically tunes the specifications of the feature extractor circuit within power or performance constraints and wherein a run-time configuration manager subsequently only activates and configures the relevant feature set by activating the relevant feature detector circuit.

According to an embodiment of the first aspect, the analog input signal may comprise an analog differential voltage signal, with a positive and negative voltage input.

According to an embodiment of the first aspect, the signal processing circuit may comprise multiple feature signal paths each for a modulated signal which represents a particular one or more features of the analog input signal, wherein at least one feature signal path comprises a programmable fabric, preferably driven by a spiking neural network, which provides control feedback to at least one other feature signal path based on the output of the programmable fabric.

According to an embodiment of the first aspect, the signal processing circuit further may comprise a convertor unit which converts the modulated signal or the error signal to a digital signal.

According to a second aspect of the present invention, a signal processing method for converting an analog input signal to a corresponding spike-time representation of the analog input signal for a spiking neural network is disclosed. The method comprises: receiving the analog input signal; producing a modulated signal which represents one or more features of the analog input signal; comparing the modulated signal with a reference signal representing a reference feature producing an error signal indicating a difference between the modulated signal and the reference signal; producing an output signal representing an occurrence of one or more of the features represented by the modulated signal; and encoding the output signal into spike trains for input to the spiking neural network.

According to an embodiment of the second aspect, the feature may be one or more of i) specific characteristics, such as transient features, steady-state features, ii) specific properties, such as (non)linearity features, statistical features, stationary features, transfer-function features, energy-content and/or based on iii) specific domain features, such as time-, delay-, frequency-, phase-domain features, preferably wherein the modulated signal represents certain time-domain features such as delay, frequency and/or phase.

### BRIEF DESCRIPTION OF THE DRAWINGS

Embodiments will now be described, by way of example only, with reference to the accompanying drawings in which corresponding reference symbols indicate corresponding parts, and in which:

FIG. 1 shows a conventional circuit for implementing a typical processing path known in the art;

FIG. 2 shows a signal processing system with analog-to-(quantity of) information converter, adaptive feature extractor and selector, spike encoder and SNN classifier according to the invention;

FIG. 3 shows an overview of the general concept of converting an analog input signal into corresponding spike-time representation, utilizing modulation techniques and feature-centric locked loops/synchronization;

FIG. 4 shows a schematic block diagram of one embodiment including analog-to-time conversion and control, and coarse and fine filtering;

FIGS. 5A-5C show the selection of local differences in a label-specific data through phase-locked data-driven feature extractors, illustrated in the time-frequency domain;

FIGS. 6A-6C shows an example of a spiking neural network response to a parameterized set of input data after feature-centric pre-processing.

### DESCRIPTION OF EMBODIMENTS

Hereinafter, certain embodiments will be described in further detail. It should be appreciated, however, that these embodiments should not be construed as limiting the scope of protection for the present disclosure.

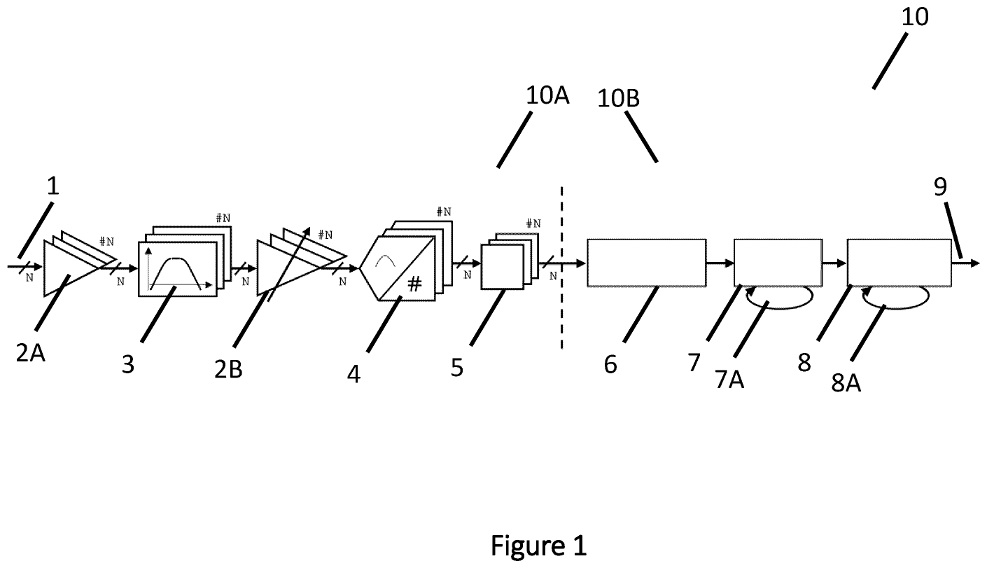

FIG. 1 shows a conventional circuit 10 for implementing a typical signal processing path known in the art. A signal processing path can form a channel in a multi-channel sensing system. The maximum number of channels can be constrained by noise, area, bandwidth, power, and/or the scalability and expandability of the sensing system.

Without loss of generality, in the conventional circuit the data acquired by the sensing element is conditioned using analog circuits in a front-end interface 10A. Each signal processing path can comprise for example a low-noise preamplifier (LNA) 2A, a band-pass filter 3, a programmable gain (post-)amplifier (PGA) 2B, an A/D converter (ADC) 4, and/or a serial interface 5.

The low-noise preamplifier 2A is typically the first element in the signal processing path. Its main purpose is to amplify the weak input signal while introducing minimal additional noise. The significance of the LNA lies in its ability to boost the signal-to-noise ratio (SNR) of the input signal, ensuring that the subsequent stages of the signal processing chain receive a sufficiently strong and clean signal for further processing.

The band-pass filter 3 allows a specific range of frequencies, known as the passband, to pass through while attenuating frequencies outside this range. The significance of the band-pass filter is to eliminate unwanted noise or interference outside the desired frequency range. It helps to isolate the signal of interest, enhance its quality, and improve the overall SNR by reducing the amount of out-of-band noise or signals.

The programmable gain amplifier 2B, also known as a post-amplifier, is responsible for adjusting the gain of the signal after it has been filtered. It allows for the amplification of the filtered signal to an appropriate level for subsequent processing stages or for matching the signal to the dynamic range of the following components. The significance of the PGA is to provide control over the signal gain, accommodating different input signal strengths or adjusting for different processing requirements.

The analog-to-digital converter (A/D converter) 4 transforms the continuous analog signal into a discrete digital representation. It samples the analog signal at a specified rate and quantizes the sampled values into digital codes. The significance of the A/D converter lies in converting the continuous-time signal into a digital format suitable for digital processing, storage, and transmission. It enables the application of various digital signal processing techniques on the captured data.

The serial interface 5 is responsible for transmitting the digitized signal to other devices or systems. It facilitates the communication between the signal processing path and other components or systems, e.g., a backend signal processing unit.

The A/D converter 4 can be shared by (post)amplifiers through time multiplexing. Alternatively, to lower demands on driving capabilities of the amplifier, and to relax power, noise and cross-talk requirements, the PGA and A/D converter can be combined and embedded in every recording channel. Hence, implementing simultaneously, both signal acquisition and amplification, as well as data conversion.

The A/D converter output can be fed to a backend signal processing unit 10B, e.g., via the serial interface. The backend signal processing unit 10B can provide feature detection using a feature detector unit 6 which may for example use a threshold, and/or extraction unit 7 for example using TTL, and can additionally or alternative perform signal classification using a classification unit 8 for example a spiking neural network. The extraction unit 7 and the classification unit 8 may each require training 7A, 8A

External influences pose significant challenges in systems where a large number of sensing (sub)elements are required for accurate representation. External influences also pose a challenge for spatially broad analysis of specific (sensed) activity, detection, or presence. External influences can be for example due to the background activity of adjacent sensing/recording elements/circuits, slight perturbations in sensing/recording element position, external electrical interference and/or external mechanical interference.

The inventors of the present invention realized therefore that the ability to distinguish or extract relevant signal information from a noisy signal depends on both the discrepancies between the noise-free data acquired from each source and the signal-to-noise level (SNR) in the recording system.

In order to detect the time occurrences of the relevant signal information or characteristic or feature set or data transition, depending on the SNR, one can use voltage thresholding e.g., with respect to an estimation of the noise amplitude in the signal, or one can use a more advanced technique, such as continuous wavelet transform, or using energy content-based techniques, such as examining the energy content of waveforms inside a slicing window.

Voltage thresholding is a signal processing technique used to classify or identify specific events or features in a voltage waveform based on their amplitude or voltage level. A threshold value is set (for example the estimation of the noise amplitude in the signal) to distinguish between signal components above and below a certain voltage level. The voltage waveform is compared against this threshold, and any portion of the waveform that crosses or exceeds the threshold is considered to have met the detection criterion. The threshold value is determined based on the characteristics of the signal and/or the specific feature of interest. This threshold can be a fixed value or dynamically adjusted based on the signal's properties or noise level. The voltage waveform is compared against the threshold value and at each sample point in the waveform, if the voltage amplitude is for example above the threshold, it is considered a positive detection, indicating the presence of the desired event or feature. Once the voltage waveform is processed through the thresholding, the identified events or features can be marked, extracted, or used for further analysis.

Continuous Wavelet Transform (CWT) is a mathematical technique used for analysing signals and data in the time-frequency domain. CWT decomposes a signal into a set of wavelet functions, called wavelets. A wavelet is a wave-like oscillation with an amplitude that begins at zero, increases or decreases, and then returns to zero one or more times. Wavelets can be compared with a brief oscillation. A wavelet correlates with a signal if a portion of the signal is similar. A mother wavelet is used to generate the different wavelets with which the signal is convoluted (and the correlation with the signal of that particular wavelet is hence determined). By varying the scale and translation parameters, the mother wavelet can be adjusted to generate a particular wavelet so as to analyse different features of the signal. The wavelet transform then decomposes the signal into a set of wavelet coefficients, capturing its time-varying frequency content. CWT thus provides a time-frequency representation of the signal, where the magnitude of the CWT coefficients represents the strength of the corresponding frequency component at a particular time. By analysing the CWT coefficients, various signal properties can be extracted, such as dominant frequencies, time localization of events, and changes in frequency content over time.

A slicing window, also known as a sliding window or analysis window, is a technique used in signal processing and data analysis to analyse a signal or data sequence in smaller, overlapping segments. It involves dividing the signal or data into consecutive and partially overlapping windows of fixed length. The window is typically defined by its length or duration, which determines the size of the segment under analysis. The step size or overlap determines how much the window shifts between consecutive segments. A larger window captures more information but provides lower time resolution, while a smaller window offers higher time resolution but captures less contextual information. By analysing the energy content within a slicing window, one can identify and detect specific events or features in a signal. For example, a slicing window can be used to capture short segments of the waveform of the signal, and the energy content within each window can be evaluated. If the energy exceeds a certain threshold, it indicates the presence of an event. The energy content within slicing windows can be used to extract relevant features from signals. By calculating statistical measures such as the mean, variance, or higher-order moments of the energy, one can characterize different aspects of the signal.

Without the loss of generality, the feature extraction (step performed to simplify and/or optimize the classification process) can be based on evident specifics of the input signal: i) specific characteristics, e.g. transient features, steady-state features, ii) specific properties, e.g. (non)linearity features, statistical features, stationary features, transfer-function features, energy-content and/or based on iii) specific domain features, e.g. time-, delay-, frequency-, phase-domain features. The complete process includes several steps, namely, i) preprocessing (including for example signal detection, energy normalization, and de-noising), ii) feature domain analysis, iii) sub-range selection, designating a selection of a range of different variables/parameters that fit on different subsets of features of interest, iv) final feature computation, and v) classification.

Transient features are temporary or short-duration phenomena that occur during the initial or transitional period of a signal or system. They represent abrupt changes or disturbances in the signal. Therefore, transient features typically exhibit characteristics such as rapid changes, high-frequency components, and short time durations. They often contain rich spectral content and have distinct temporal profiles. The analysis of transient features can require for example high time resolution and the ability to track rapid changes in the signal. Techniques such as time-domain analysis, waveform analysis, or high-resolution time-frequency analysis (such as the continuous wavelet transform introduced above) are commonly used for transient feature extraction. Steady-state features, on the other hand, represent the long-term or stationary behaviour of a signal or system after the initial transient period has passed. They correspond to the stable or recurring part of the signal that persists over an extended duration when the system has reached a steady state. Steady-state features exhibit characteristics such as relatively constant amplitudes, stable spectral components, and regular temporal patterns. Analysing steady-state features typically involves examining properties such as average amplitude, frequency content, statistical measures, harmonic structures, or periodicity. Techniques such as Fourier analysis, power spectral density estimation, or statistical analysis can be used to analyse steady-state features.

Analysing a signal based on specific properties involves applying specific techniques or methods to extract the relevant information for each feature.

For example, for (non)linearity features, one could perform either phase space reconstruction (in order to determine the underlying dynamics of the signal, which can reveal nonlinear behaviour and provide insights into system complexity) or one could determine Lyapunov exponents (which quantify the degree of chaos or predictability in the signal; higher exponents indicate chaotic or nonlinear behaviour).

For statistical features, one could for example calculate statistical measures such as mean, variance, skewness, and kurtosis to characterize the distribution and central tendencies of the signal. Furthermore, one could for example calculate the autocorrelation function to analyse the temporal dependencies or repeating patterns in the signal.

For stationary features, one could for example apply Fourier transform techniques or spectral analysis techniques to examine the frequency content and power spectrum of the signal. This helps identify dominant frequencies and spectral characteristics. Furthermore, one could perform wavelet analysis, such as Continuous Wavelet Transform (CWT) or Discrete Wavelet Transform (DWT), to analyse the signal's time-frequency properties and identify localized features.

For energy content, one could for example calculate the energy or power of the signal within specific frequency bands or time windows to identify dominant frequency components or assess the signal's power distribution. Another option could be to apply short-time Fourier transform to obtain a time-frequency representation of the signal and analyse energy distribution over time and frequency. Another option could be to extract the envelope of the signal by using techniques like Hilbert transform or amplitude modulation analysis, and subsequently to analyse the energy variation of the envelope of the signal.

Analysing a signal based on specific domain features, such as time, frequency, or phase, can involve applying domain-specific techniques to extract relevant information.

For a time-domain analysis, one can calculate statistical measures, for example the mean, variance, and higher-order moments of the signal, to characterize its amplitude distribution and variability. Furthermore, one can apply techniques such as autocorrelation to identify repeating patterns or periodic components in the signal.

For a frequency-domain analysis, one can apply for example Fourier transform or Fast Fourier Transform (FFT) techniques to convert the signal from the time domain to the frequency domain. This yields the frequency spectrum of the signal, from which one can analyse the magnitude and phase of its frequency components. The power spectral density can be determined, which can provide insight into the distribution of power across the different frequencies from which the signal is built. A Short-Time Fourier Transform (STFT) can be used to determine the signal's time-varying frequency content.

For a phase-domain analysis, one can extract the phase component of the signal through the application of techniques such as Hilbert transform or phase unwrapping. This can reveal phase relationships between different frequency components or oscillations. A measure of phase coherence can be measured, such as the phase locking value (PLV), to assess the degree of synchronization or coupling between different oscillatory components.

One can compare the time-domain waveform, frequency spectrum, and phase relationships together to gain a more comprehensive understanding of the signal's characteristics. For example, one can use time-domain analysis to detect transient events or sudden changes in the signal, and then examine their frequency and phase characteristics. Furthermore, one can investigate time-frequency dynamic to analyse how the signal's frequency content changes over time.

It can be valuable to use a combination of techniques to obtain a comprehensive analysis of the signal.

Based on these (extracted) features the relevant data can be classified into m-dimensional clusters by k-means, expectation maximization (EM), template matching, Bayesian clustering, and artificial neural network (ANN) or spiking neural network (SNN), with each cluster corresponding to the activity of a single sensing element/signal channel.

The result of the classification process is thus the formation of m-dimensional clusters. Clusters represent groups of data points that have similar feature patterns or characteristics. The extraction of features involves transforming the raw data into a reduced set of meaningful features that capture relevant information. The clusters are formed based on the similarity or proximity of these extracted features. Data points within the same cluster are more alike in terms of their feature representations than data points in different clusters. The dimensionality “m” of a particular cluster refers to the number of features or variables used to describe the data points within that cluster. Each cluster represents the activity or behaviour of a single sensing element or signal channel. In other words, the data points within each cluster are similar to each other based on the extracted features, indicating that they belong to the same sensing element or signal channel.

The unsupervised learning algorithm k-means clustering groups data points into clusters based on similarity. The “k” represents the desired number of clusters.

EM is a statistical algorithm commonly used for clustering and classification, particularly in the presence of hidden or latent variables. It iteratively estimates the parameters of a statistical model to assign data points to appropriate clusters.

Template matching is a technique where a predefined template or pattern is compared to the data, and similarity measures are used to identify matches or correspondences. It is often used for pattern recognition and signal matching.

Bayesian clustering applies Bayesian inference principles to cluster data points. It incorporates prior knowledge and updates probabilities to determine the most likely clusters for the data.

An artificial neural network is a signal processing system composed of interconnected artificial neurons organized in one or more layers. Each artificial neuron receives input signals, combines them with specific weights, and applies an activation function to produce an output. The connections between neurons, called synapses and having adjustable weights, allow information to propagate through the network, enabling the network to learn and make predictions or decisions based on input data. ANNs do not inherently consider the timing of events or the temporal dynamics of information. They are mainly concerned with the magnitudes of inputs and their propagation through the network.

Spiking neural networks (SNNs) are signal processing systems whose design is inspired by biological neural networks. Information is encoded in patterns of spike signals distributed across a network of neurons and synapses, as described in WO2022/090542A1 filed by the present applicant and incorporated herein by reference in its entirety. By mimicking the processes occurring in biological brains, spiking neural networks can perform signal processing tasks that are typically performed by human brains. Examples include image recognition, sound recognition and detection of events based on input from multiple sensors.

Without loss of generality, the present invention implements feature processing/classification as a neuromorphic event-based neural network. The time-continuous SNN architecture offers a platform that minimizes size and power consumption in real-time behaving systems by explicitly matching the computing principles underlying autonomous adaptive behaviour. In the time-continuous spiking architecture, the state variables evolve naturally over time, bypassing the need to have clocks and extra circuits to manage the representation of time; the circuits are driven directly by the input data, i.e. the synapses receive input spikes, and neurons produce output spikes at the rate of the incoming data. Hence, in the case of applications in which the signals have sparse activity in space and time, most neurons would be silent at any one time, thus, bringing the system power consumption to the minimum. In essence, such (time-aware spiking) neural network implementations adopt a hybrid analog-digital signal representation, i.e. the trains of pulses/spikes transmit analog information in the timing of the events, which are converted back into analog signals in the dendrites (inputs) of the neuron.

In the neural systems, a multitude of information encoding schemes exist, which are specifically utilized to efficiently represent particular data forms (e.g. visual, acoustic, somatic) originating from different senses. For the neurological computation, such encoding schemes are differentiated in two broadly defined, competing approaches, the rate-based, and temporal spike-based encoding. In the rate-based encoding the information representation and computation is not based on the individual spikes but on the spike firing rate, i.e., the information is embedded in the instantaneous or averaged rate of spike generation of a single or group of neurons, and the scheme can be, consequently, subdivided into count, density, and population rate encoding. Count encoding can emphasize the absolute number of spikes, density encoding can normalize the count by considering the time window in which the count was taken, and population rate encoding can take into account the average firing rate of a group of neurons.

When designing a real-time neuromorphic system, the eventual choice of the particular encoding scheme should be evaluated from the different perspectives, namely, algorithmic level, training process, and hardware implementation perspective, and their impact and performance indicators and parameters evaluated in a wide-ranging scope, e.g. in terms of classification accuracy, processing latency, energy consumption, number of synaptic operations, hardware costs, network compression efficacy, noise resilience, and fault tolerance.

For practical implementation of the proposed feature extraction mechanism, it may be important that the signal modulation details and its inherent relationship with signal distortions caused by hardware imperfections, especially for low SNRs, is included.

The features can be activated, e.g. feature extraction on the basis of a feature can be performed, and configured at run-time along several parameters such as region or window length in the time, delay, frequency or phase domain, gain, bandwidth, etc. The region/window length can be important when considering for example feature extraction based on an inhomogeneous property of the signal in the form of specific distribution sub-regions rather than defining it as evenly distributed (along the entire original feature). The signal modulation aspects can thus be characterized by the signal's inhomogeneity property in the form of specific distribution sub-regions. Hence, for selection, the feature vector can be segmented into multiple overlapping sub-regions. The overlap can be considered as a sliding window with the width of w, and the sliding step s to filter the entire feature, satisfying s=[(n−w)/k], where n is the feature length, and k is the number of windows. Without loss of generality, to emphasize the specific feature performance/separability, the interclass and intraclass feature dispersion of each window is measured, and sub-region(s) with strong class separability are selected. In order to do this, one can for example measure the separability using a pre-defined metric.

Interclass feature dispersion refers to the distribution or spread of feature representations between different classes or categories in a classification problem. It measures the degree of separation or dissimilarity between the feature representations of different classes. The interclass feature dispersion can be important for classification tasks because well-separated classes make it easier for a classifier to distinguish between them. When classes have low interclass feature dispersion, they may overlap in feature space, leading to higher classification errors or ambiguity. On the other hand, high interclass feature dispersion facilitates better discrimination and classification accuracy.

Intraclass feature dispersion refers to the distribution or spread of feature representations within the same class or category in a classification problem. It measures the degree of variation or dissimilarity between feature representations belonging to the same class. By minimizing intraclass feature dispersion, a classifier can better capture the distinctive characteristics shared by instances within the same class. This leads to improved classification accuracy as the classifier can make more confident and accurate predictions.

One can thus enhance the separability and distinguishability of different classes by maximizing the interclass feature dispersion while minimizing the intraclass feature dispersion.

The representative features with the distribution characteristics of different devices (e.g. integrated circuits and systems processing specific sensor signal) can be obtained using statistical methods, for example evaluating the size of the local difference between the representative features (e.g. in a separable feature space) and determining the location of its concentrated distribution based e.g. on weighted entropy.

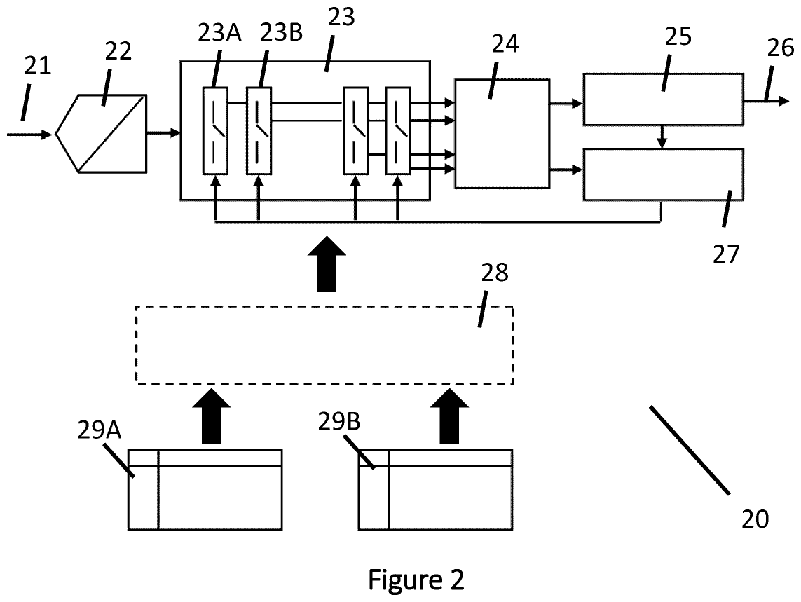

FIG. 2 shows a signal processing system 20 with an analog-to-(quantity of) information converter, adaptive feature extractor and selector, spike encoder and SNN classifier according to the invention.

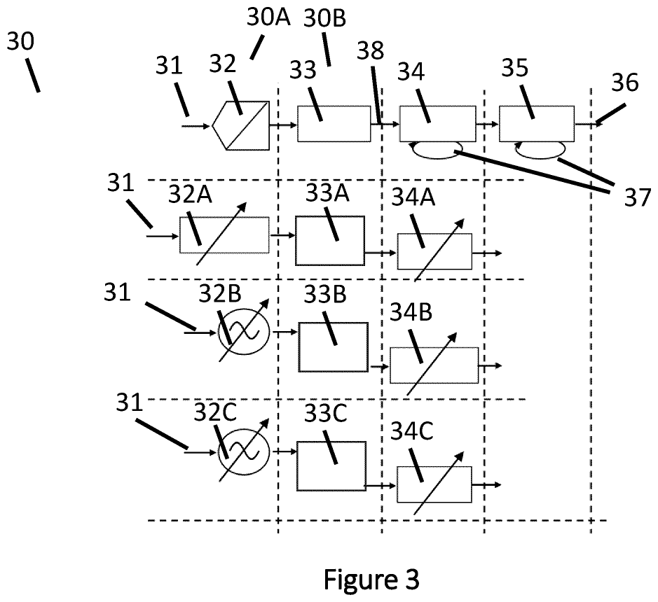

A physical input signal 21, which may or may not have been pre-conditioned enters the signal processing system. The conditioning can comprise the usage of for example a low-noise preamplifier (LNA), a band-pass filter, a programmable gain (post-)amplifier (PGA). The analog-to-(quantity of) information (A(Qo)I) converter, more generally analog-to-information converter 22, takes the (analog) physical input signal 21 and may extract only the most relevant information from the analog signal 21 for the given application towards its digitization. The output of the A(Qo)I convertor 22 can be a modulated signal of the input signal, further explained using the example of FIG. 3. In particular, the A(Qo)I converter 22 obtains evident specifics of the physical input signal 21, for example as mentioned before: i) specific characteristics, e.g. transient features, steady-state features, ii) specific properties, e.g. (non)linearity features, statistical features, stationary features, transfer-function features, energy-content or based on iii) specific domain features, e.g. time-, frequency-, phase-domain features.

Next, the modulated signal generated by the A(Qo)I converter 22 is sent to a channel selector unit and extractor unit 23. As mentioned, each signal channel that the channel selector unit and extractor unit 23 can select may correspond to a particular cluster wherein each cluster represents the activity of the signal channel and is described by a particular basis of features. Data in the physical signal 21 can thus be classified in one or more clusters, depending on which features that are present in the signal. Note that if the A(Qo)I converter comprises a Voltage-Controlled Delay line or a Voltage-Controlled Oscillator, a Voltage-Controlled Delay line and a Voltage-Controlled Oscillator may be used that are event-driven, so if the signal is present at the input of A(Qo)I 22 the signal will be present afterwards at the input of the subsequent signal channel. The task of adaptable extractors/filters is to pass only relevant signal information to the SNN inference and control machine 25.

The extractor unit 23 may comprise a set of parallel feature extractors 23A, 23B etc., each functioning as a channel selector, each channel representing a (sub)-region of the relevant feature domain. For example, a channel may be defined by a certain (sub)-region of a delay, frequency or phase domain of the input signal. The channel selector unit may be adaptive in such a way that a subset of features most beneficial under specific operating conditions at any given moment in time is activated, so that the one or more signal channels corresponding to the subset of features of interest can be adaptively selected, and information on those features are extracted from the signal from the A(Qo)I converter by the parallel feature extractors comprised in the extractor unit.

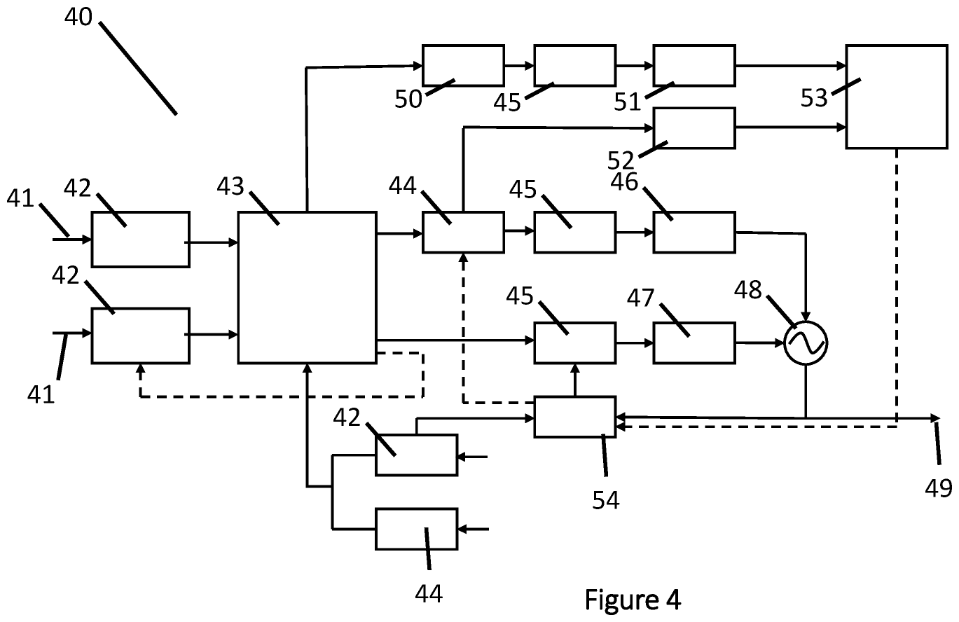

Thus, this approach may require a set of configurable feature extractors. In one embodiment, feature extraction is performed by the feature extractors through feature-centric adaptive filters/locked loop/synchronization techniques. Feature extraction is in general circuit/system specific in the way it is configurable, i.e. through the specific circuits parameters (e.g. gain, linearity, bandwidth), and system (feed-forward and feed-back) control parameters. For example, in the embodiment of FIG. 4, coarse/fine selectivity, ATC control, feedback control, calibration, timing, delay, sampling/sub-sampling mode selection are all configurable/programmable.

The features generated by the extraction unit 23 are fed to a classifier or information extractor that performs the application specific information estimations, e.g., speech identification.

For example, the features coming from the extraction unit 23 are fed, for example via a multiplexer, to a spike encoding stage 24. The features are encoded by the spike encoding stage 24 into spike trains, which are sequences of spikes (action potentials) that represent the information in a temporal and event-based manner. As mentioned, rate-based or temporal, spike-based encoding could be used for the encoding scheme. In this manner, the feature information extracted from the physical signal is converted to the timing, rate, or pattern of spikes which are then fed into a SNN processor or classifier 25.

The SNN outputs information, and/or an inference metric 26 which is a quantitative measure used to assess the performance of the classification of the physical signal by the SNN. The SNN inference machine can outputs two signals: (i) an inference result, that is designation of the specific class the input signal belongs to, and (ii) an inference metric, for example inference accuracy as a quantitative measure to assess the performance of the classification of the physical signal.

As mentioned, the SNN 26 can perform inference/classification. Furthermore, the SNN can perform, although as a separate implementation, also control functions. The application/context/condition detection block 27 represents such a control machine, which controls circuit and system parameters, e.g. the adaptive channel selector and extractor. The application/context/condition detection block receives two inputs, one from the SNN inference machine (for example inference accuracy), and the second from the selector, extractor and encoding stage, which needs to be controlled or calibrated. For example, see FIG. 4 for more explicit details.

Confidence on resulting estimations strongly depends on environmental conditions such as signal dynamics or signal interference. At run time, the application/context/condition detection block 27 determines the current operating context and hence the optimal analog feature sets. A feedback loop dynamically tunes the specifications of the feature extraction unit within power or performance constraints. A run-time configuration manager of the selector unit and extractor unit subsequently only activates and configures the relevant feature set.

The parameter block 28 designates the parameters upon which the selector/control unit operates to optimize specific Figure of Merit that is Figure of Efficiency (for example, energy-efficiency, energy-throughput efficiency, energy-throughput-accuracy efficiency), or only specific task (for example noise filtering, variability limitation/bounding/calibration, channel synchronization or signal alignment). Training and test data across processing tasks 29A can be required as input to know which (performance parameters) settings to choose for a particular processing task. Furthermore, parametrized performance settings 29B can be used as input to the parameter block.

It should be noted that the extraction of features incurs a specific cost, for example computational (e.g. searching for a specific pattern vs. counting the number of occurrences) or memory costs (e.g. to store the (running) value of a feature). Consequently, if for the pattern recognition (or classification) the cost (or the budget available in terms of power/performance/area (PPA)) of features extraction is included into consideration, the performance of the classifier depends on the cost of features used. (Feature) memory cost depends on, among others, the number of features and feature vector size/accuracy. What kind of memory device (e.g., flip-flop-based, MOS capacitor-based, or floating-gate based) is utilised depends on the circuit implementation. The running value of a feature may be used in the feature extractor.

FIG. 3 shows an overview of a system 30 for converting an analog input signal 31 into corresponding spike-time representation, utilizing modulation techniques and feature-centric locked loops/synchronization. The system of FIG. 3 illustrates various optional circuits for processing an input signal in the delay, frequency and/or phase domains, may be implemented in the circuit shown in FIG. 2. For example, the A(Qo)I converter 32 may be implemented as A(Qo)I converter 22, the detector circuit 33 and feature extractor 34 may implemented as the channel selector and extractor 23, the spike encoding stage and classifier 35 may be implemented as spike encoder 24 and classifier 25.

A physical signal 31, which may be preconditioned, enters the A(Qo)I converter 32, which may be regarded as part of the front-end interface 30A, from which a modulated signal is obtained. The conditioning can comprise the usage of for example a low-noise preamplifier (LNA), a band-pass filter, and/or a programmable gain (post-)amplifier (PGA). The A(Qo)I converter may comprise an analog-to-delay (A/delay) converter 32A, an analog-to-frequency (A/frequency) converter 32B, and/or an analog-to-phase (A/phase) converter 32C. The input signal may also be converted into other parameters than delay, frequency or phase. The physical signal may be in a voltage representation, and can be used as a control voltage input to each of the one or more converters. The A/delay converter 32A may comprise a voltage-controlled delay line (VCDL). The A/frequency converter 32B may comprise a voltage-controlled oscillator (VCO). The A/phase converter 32C may comprise a multiphase voltage-controlled oscillator (multiphase VCO). The physical signal, which may be used as a control voltage input to each of the converters, thus determines the amount of delay, frequency and/or phase of the modulated signal. For example, for an A/frequency converter 32B, the physical signal may used as the control voltage input of the VCO, and a higher voltage input creates a higher frequency of the modulated output signal.

Next, the modulated signal may be fed into a detector circuit 33, which may comprise delay detector circuit 33A, a frequency detector circuit 33B, and/or a phase detector circuit 33C, where e.g. the delay, frequency and/or phase is compared with a respective reference delay, frequency and/or phase signal. The reference may be pre-determined or dynamically determined. The detector 33 may thus produce an error signal 38 which is proportional to the difference between the modulated signal and the reference signal with respect to e.g. delay, frequency and/or phase. The error signal may then be filtered and used to drive a feature extractor 34.

Feature extractor 34 may comprise a VCO 34A, 34B, and/or 34C which creates an output delay, frequency and/or phase signal. Furthermore, adaptive filters may be present in the feature extractor 34. The filter may stop the error signal 38 if it is not in the locking range of the VCO 34A, 34B, 34C, but if the error signal 38 is in the locking range it may pass through. The output signal may represent an occurrence of one or more of the features represented by the modulated signal in time, but may also represent a chance (e.g. specified probability) that a feature is present in the signal at a particular time. The output signal may be fed back to the input of the system, producing a negative feedback loop. If the output delay, frequency and/or phase drifts, the error signal will increase, driving the VCO's delay, frequency and/or phase in the opposite direction so as to reduce the error. Thus, the output delay, frequency and/or phase is locked to the respective delay, frequency and/or phase of the modulated signal or to the error signal.

The detector circuit 33 and feature extractor circuit 34 may be implemented with a set of parallel circuits (e.g. as shown in the feature extractors/channel selectors 23A, 23B of the FIG. 2 embodiment) which perform detection and feature extraction for a respective signal channel, each channel representing a sub-region of the relevant delay, frequency or phase domain of the input signal.

The output signal of the feature extractor 34 is fed to a spike encoding stage 35 which encodes the output signal into spike trains. As mentioned, rate-based or temporal, spike-based encoding could be used for the encoding scheme. In this manner, the feature information extracted from the physical signal 31 is converted to the timing, rate, or pattern of spikes which are then fed into a SNN processor or classifier, also referenced with numeral 35. The spike encoding stage and classifier may be implemented together as one circuit or separately. The output of the spike encoding stage and the classifier 35 can be e.g. a classification metric 36. Training 37 of the feature extraction circuit 34 and the encoding circuit 35 may be required, as well as for the classifier.

The type of encoding used in encoding circuit 35 may vary depending on the type of parameters used in the converter 32, detector 33 and feature extractor 34. When looking at the delay parameter, one could use time-to-first spike (TTFS), inter-spike interval (ISI), burst, or delay synchrony encoding. When looking at the frequency parameter, rate or frequency synchrony encoding might be used. When looking at the phase parameter, phase or phase synchrony encoding might be used.

Time-to-first-spike encoding is a method used in spiking neural networks (SNNs) to represent information based on the timing of the first spike generated by a neuron in response to a stimulus or input. In this encoding scheme, the information is represented by the time it takes for a neuron to fire its first action potential (spike) after receiving a particular input. In time-to-first-spike encoding, neurons are configured in a way that they respond quickly to specific features or patterns in the input, and the first spike encodes the presence of those features. For example, if a neuron is sensitive to a certain visual pattern, it will fire its first spike rapidly when it detects that pattern in the input.

Inter-spike interval (ISI) encoding is a method used in spiking neural networks (SNNs) to represent and process information based on the timing of spikes generated by neurons. In ISI encoding, the information is represented by the time intervals between successive spikes emitted by a neuron. Each spike can be time-stamped, and the duration between two consecutive spikes is measured as the inter-spike interval. The pattern of inter-spike intervals carries the information about the input being processed.

Burst encoding in spiking neural networks is a method used to represent and process information by encoding patterns of spikes in short bursts or bursts of action potentials. It involves a group of spikes generated closely in time, often with high-frequency firing, followed by a period of relative inactivity before another burst of spikes occurs. In traditional single-spiking neurons, information is typically encoded in individual spikes. However, in burst encoding, information is represented in the temporal pattern of bursts.

In rate encoding, the information is represented by the frequency or rate at which a neuron generates spikes over time. Higher firing rates typically indicate the presence or strength of a particular feature in the input data, while lower firing rates may signify the absence or weaker representation of that feature. The key idea behind rate encoding is to take advantage of the temporal integration of spike trains. Instead of considering individual spikes, the network looks at the accumulated activity over a period. Rate encoding may rely on the aggregate firing rate of spiking neurons over time, or the average firing rate of a neuron over a certain time period.

Phase encoding is a method used to represent and process information by encoding it in the relative phase relationships between spikes emitted by different neurons. This encoding scheme takes advantage of the precise timing of spikes to convey information. In phase encoding, neurons may be designed or tuned to fire their spikes at specific phases of a periodic cycle. For example, a neuron might be configured to fire at the peak of an oscillatory signal or at a specific phase of a rhythmic input. The relative phase relationships between the spikes of different neurons encode information about the input. The key idea behind phase encoding is that the timing of spikes carries valuable information, and by synchronizing the spikes of multiple neurons to specific phases, the network can represent and process specific features or temporal patterns in the input data.

Synchrony encoding (either using e.g., delay, frequency, or phase) in spiking neural networks is a method used to represent and process information by encoding patterns of synchronous spikes among different neurons. It involves neurons firing action potentials at the same time or in close temporal proximity to convey specific information or encode certain features of the input. Synchrony encoding takes advantage of precise timing in the form of synchronized spiking activity across multiple neurons to represent information efficiently. The simultaneous or nearly simultaneous firing of neurons can convey information about correlations, patterns, or specific features in the input data. For instance, the presence of a particular feature in the input might be represented by neurons firing simultaneously, while the absence of the feature might lead to desynchronized or uncorrelated activity.

Without the loss of generality, in the present invention, converting an analog input signal into corresponding spike-time representation in the A(Qo)I converter 32 comprises firstly translating the (quantity of) signal information in the transitions (instead of the instantaneous amplitude) of the input signal 31 by some modulation form, i.e. representing and processing of the signals by using (spike-time) properties as the delay, frequency, and phase of the signals. Transitions here can be between two well-defined values, for example between ground and power supply voltage levels of the input signal. Correspondingly, this analog to (quantity of) information-e.g., analog to delay, analog to frequency, analog to phase conversion enables manipulation of sampled information using delay-, frequency-, phase-difference variables as the relevant event occurring with respect to a reference.

As mentioned, the relevant information is extracted through feature-centric adaptive filters/locked loop/synchronization techniques in detector circuit 33 and feature extractor circuit 34, before modulation-matched signal feature encoding (e.g. for analog to phase modulated signals features are extracted through phase-locked loops and represented with phase encoding), and classification/recognition is executed. In one embodiment of the present innovation, time modulation (i.e. analog to time conversion) is performed with (adaptive) voltage-controlled delay line (VCDL) circuit. In another embodiment, frequency modulation is completed with voltage-controlled oscillator (VCO).

VCO-based analog to frequency conversion offers high gain, high frequency, low-power, high linearity and small implementations through different trade-off mechanisms. In yet another embodiment, phase modulation (i.e. analog to phase conversion) is performed with multi-phase VCO circuit. After completing pulse modulation, relevant information is extracted and selected through feature-centric locked loop/synchronization techniques (e.g. delay-locked loop (DLL), frequency-locked loop (FLL) and phase-locked loop (PLL)), corresponding to delay-, frequency-and phase-modulation, respectively. DLL is a circuit similar to a phase-locked loop with the main difference being the absence of an internal VCO, replaced by a delay line.

In one embodiment, delay/frequency/phase detector circuit 33 uses the output delay/frequency/phase difference to close the feedback loop, providing an up/down feedback signal. When up/down signals are combined and added to a discriminator (e.g. feature selector 34), the response of the feature of interest is extracted, i.e., matching the inputs delay/frequency/phase to the reference's delay/frequency/phase in the detector circuit 33.

A signal processing circuit 30 for a spiking neural network is thus disclosed which may comprise an interface for converting an analog input signal 31 to a corresponding spike-time representation of the analog signal. The interface may comprise a delay circuit 32A for converting the analog input signal to a corresponding delay input signal having a value representing a delay of the analog signal, a frequency circuit 32B for converting the analog input signal to a corresponding frequency input signal having a value representing a frequency of the analog signal, and/or a phase circuit 32C for converting the analog input signal to a corresponding phase input signal having a value representing a phase of the analog signal. The signal processing circuit 30 further may comprise a feature extraction unit 34 comprising a delay signal processing circuit 33A, 34A connected to receive the delay input signal, a frequency signal processing circuit 33B, 34B connected to receive the frequency input signal, and/or a phase signal processing circuit 33C, 34C connected to receive the phase input signal.

The delay circuit 32A may comprise a voltage-controlled delay line circuit having an input for receiving the analog input signal 31, wherein the voltage-controlled delay line circuit 32A is configured to generate the delay input signal. The frequency circuit 32B may comprise a voltage-controlled oscillator circuit having an input for receiving the analog input signal 31, wherein the voltage-controlled oscillator circuit is configured to generate the frequency input signal. The phase circuit 32C may comprise a multiphase voltage-controlled oscillator circuit having an input for receiving the analog input signal 31, wherein the multiphase voltage-controlled oscillator circuit is configured to generate the phase input signal.

The delay signal processing circuit 33A, 34A may comprise a delay-locked loop circuit having a first input for receiving the delay input signal and a second input for receiving a delay reference signal, wherein the delay-locked loop circuit is configured to generate a delay output signal based on a comparison of the delay input signal and the delay reference signal. The frequency signal processing circuit 33B, 34B may comprise a frequency-locked loop circuit having a first input for receiving the frequency input signal and a second input for receiving a frequency reference signal, wherein the frequency-locked loop circuit is configured to generate a frequency output signal based on a comparison of the frequency input signal and the frequency reference signal. The phase signal processing circuit 33C, 34C may comprise a phase-locked loop circuit having an input for receiving the phase input signal and a second input for receiving a phase reference signal, wherein the phase-locked loop circuit is configured to generate a phase output signal based on a comparison of the phase input signal and the phase reference signal.

FIG. 4 shows a schematic block diagram of one embodiment 40 including analog-to-time conversion and control, and coarse and fine filtering.

Without the loss of generality, in this disclosure, time-based feature-centric locked loop/synchronization processing circuit enables manipulation of sampled analog information using time-difference variables as the quantity of time between an event occurring with respect to a reference time or event.

The time encoding consists of representing an analog signal with a modulated square wave, where the signal information is encoded in the transitions instead of the instantaneous amplitude, i.e. the input signal is converted into a time-difference variable. Hence, the time signal is then processed by various circuits resulting in a time-difference output, where a pulse modulator encodes the analog input signal information in the pulse width, frequency or position of a signal (or set of signals) with two levels only. This two-level signal, which is still analog, is sampled afterwards at a sampling frequency. The sampler can now be a simple D-type edge-triggered flip-flop-based as the signal has only two values. From the sampled square wave, a multi-bit approximation of the analog input signal can be reconstructed with a digital low-pass filter. A conversion of a time interval between two clock edges into a digital number is performed with time-to-digital converter (TDC). As with all sampling processes, the continuous time signal must be band-limited to prevent aliasing effects. In one embodiment, a PLL is utilized to band limit the phase-modulated input signal. A TDC can be realized with time comparators (D flip-flops) and other digital blocks, e.g. single counter, flash TDC, Vernier oscillator, cyclic pulse-shrinking TDC.

The circuit includes a programmable analog to time (A/T) converter, coarse-, and an enhanced range fine-tuner of the in-loop filter characteristics, aided with a background calibration mechanism to reduce the effect of non-idealities. It combines the advantages of the sampling loop and the sub-sampling loop to achieve robust time, phase and frequency acquisition under frequency disturbances and low-power operation. During the switching process from the sampling to the sub-sampling loop, the phase remains locked without any discontinuities.

In one embodiment, the circuit performs firstly analog to time conversion (ATC), i.e. as the analog voltage is sensed, conversion in a time pulse is performed, embedding the analog information to a time period between a rising and a falling edge. The analog signal and its differential signal (180° phase shifted) are offered to two voltage-controlled delay line circuits, hence, their output signals are time pulses that depend on the input signal amplitude. To obtain sufficient dynamic range, a control circuit is added to combine the outputs of voltage-controlled delay line circuits, and subsequently create a single time pulse that represents the analog input signal by the duration of the pulse width. The control circuits also average a programmable number of samples, obtaining targeted oversampled ratio.

To improve the phase lock time, a coarse T/D converter is inserted after the phase detector to quantize the coarse phase error and assist with coarse phase and frequency locking. The phase detector and the frequency detector work in conjunction with the switching feedback, which monitors frequency disturbances and ensures that the digital control oscillator (DCO) is always locked to the correct frequency. However, directly switching from the sampling mode to the sub-sampling mode in the feedback path will cause phase discontinuity due to the delays in the feedback path. Hence, an additional delay is inserted after ATC to mitigate phase discontinuity. When the sampling mode is engaged for input signal time/frequency/phase acquisition, the (SNN) controller produces relevant information for control of the feedback loop and A/T conversion. If the PLL is locked to incorrect frequency, a frequency detector can be used to switch the feedback from the sub-sampling mode to the sampling mode for frequency locking.

In more detail of the present embodiment, an input signal enters an analog-to-time converter. The input signal may be a differential signal, comprising a positive and negative input voltage, to obtain better dynamic range. The positive and negative input voltage may each be passed through a voltage control delay line before entering the analog-to-time converter. The input signal may be pre-conditioned, the conditioning can comprise the usage of for example a low-noise preamplifier (LNA), a band-pass filter, a programmable gain (post-)amplifier (PGA).

The analog-to-time converter is a converter which converts the analog input (voltage) signal—which may be pre-processed or may comprise several input voltages (as for a differential signal)—into a time parameter. The time parameter may be e.g. delay, frequency and/or phase, as was detailed with respect to FIG. 3. In the present embodiment, the analog-to-time converter converts the analog input signals into delay, frequency and phase modulated signals, but more or less conversions may take place.

Next, there are essentially four signal paths: a frequency signal path, a delay signal path, a coarse phase signal path and a fine phase signal path.

The coarse phase signal path may comprise e.g. a phase detector 44, a time-to-digital converter 45 and a coarse filter 46. The fine phase signal path may comprise e.g. a delay block, a time-to-digital converter 45, and a fine filter 47. Both the coarse phase signal path and the fine phase signal path are connected with a digital controlled oscillator 48 and each form a phase locked loop as disclosed above. As mentioned, the phase lock time of the fine phase locked loop may be improved by using the coarse phase locked loop so as to quantize the coarse phase error and assist with coarse phase locking. The output signal 49 of the digital controlled oscillator 48 may be fed to a spike encoding stage as mentioned above, which encodes the output signal into spike trains. As mentioned, rate-based or temporal, spike-based encoding could be used for the encoding scheme. In this manner, the feature information extracted from the physical signal is converted to the timing, rate, or pattern of spikes which may then be fed into a SNN processor or classifier.

The frequency signal path may comprise e.g., a timer control 50, a time-to-digital converter 45 and a digital frequency detector 51. The timer control 50 may make sure that the different signal paths are synchronized. The delay signal path may comprise e.g. a phase detector 44 and delay control logic 52. In the present embodiment, both the frequency signal path and the delay signal path are connected to a programmable fabric 53, e.g., a spiking neural network.

The programmable fabric 53, connected to the frequency and delay signal paths, and/or the digital controlled oscillator 48 may provide an output signal to the control feedback, 54 which may provide feedback to one or more of the different signal paths and/or the analog-to-time converter 43. In the example, the control feedback provides feedback to the coarse and fine phase signal paths, as well as the analog-to-time converter 43.

The control feedback 54 may further be controlled by a control signal coming from a control block 42. The control block 42 may be driven by a spiking neural network. The control block 42, together with a calibration block 44 may through e.g., programmable logic, control the analog-to-time converter 43. The calibration block 44 may be responsible for calibrating specific parts of the entire signal processing module, and may take as input certain system settings or calibration data.

Note that while one analog-to-time converter 43 is shown, multiple can be present in the signal processing path. Furthermore, in general the analog-to-time converter can be an A-to-Information converter or an analog-to-quantity-of-information converter, not just extracting time parameters of the signal such as for example frequency, delay and/or phase, but also other parameters of the signal which may be of interest for the specific application.

The different feature signal paths (e.g. frequency signal path, delay signal path and phase signal path) can be phase locked by connection to a digital controlled oscillator or can e.g. connected to a programmable fabric. One or more of the feature signal paths can be left out or added. For example, a frequency-locked loop signal path and/or a delay-lock loop signal path can be added. Instead of a fine and coarse phase signal path, only one phase signal path can be used which may or may not be a phase-locked loop signal path. Multiple signal paths for the same feature may exist (such as fine and coarse phase, or frequency control and frequency-locked loop, as examples).

In other words, a feature signal path has as input a feature modulated signal coming from an A(Qo)I converter and can be for example a feature-locked loop, non-feature-locked loop, an adaptive filter loop, a synchronization loop and/or can be used as control (feedback) for other parts of the signal processing module (e.g. another feature signal path).

By utilizing a feature signal path which is a feature-locked loop, the relevant feature values equal to the reference signal can be selected and the resulting output signal may be fed into an encoder and classifier. In this way, the original non-sparse input signal may in some cases be made sparse, by filtering out irrelevant information from the signal. Further rectification and calibration can be performed on the input of the signal, before and or after the signal processing module.

While above a time-to-digital converter was used in some of the feature signal paths, the feature signal paths can remain completely analog. Further timer blocks or delay blocks can be added to the different feature paths in order to synchronize the different feature signal paths in the correct manner.

Note that coarse/fine selectivity, ATC control, feedback control, calibration, timing, delay, sampling/sub-sampling mode selection are all configurable/programmable and the feature extraction can be made configurable in this manner.

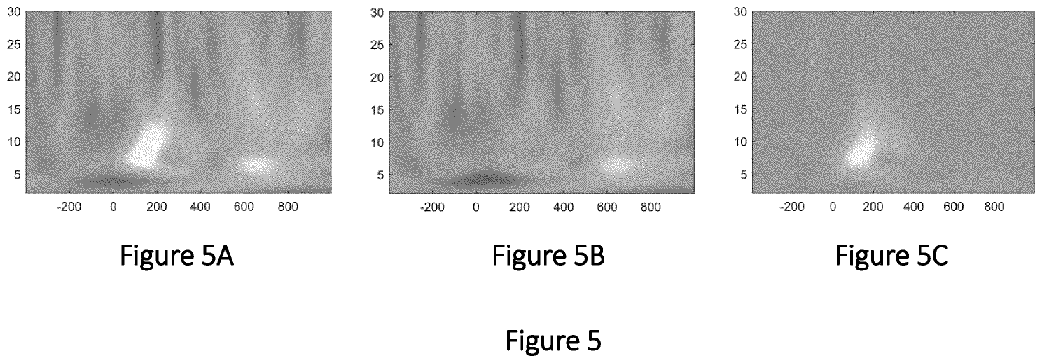

FIG. 5 illustrates an example of phase-locked feature extraction. In particular, it shows an example of selecting local differences in a label-specific data through a phase-locked (e.g. through the assessment of phase angle of voltage shifts) data-driven feature extractors illustrated in time-frequency domain. FIG. 5A shows a spectrogram of an input signal. FIG. 5B is a spectrogram of the same signal but showing those elements of the signal with a differing phase from the applicable phase reference signal used to extract relevant features from the input signal. FIG. 5C is a spectrogram of the same signal but showing those elements of the signal extracted by the feature extraction circuit, having a phase similar to the applicable phase reference signal. Each spectrogram shows time in microseconds on the horizontal axis, and frequency in kilohertz on the vertical axis. As can be clearly seen, through phase-locking a feature of interest can be selected successfully from the entirety of the input signal.

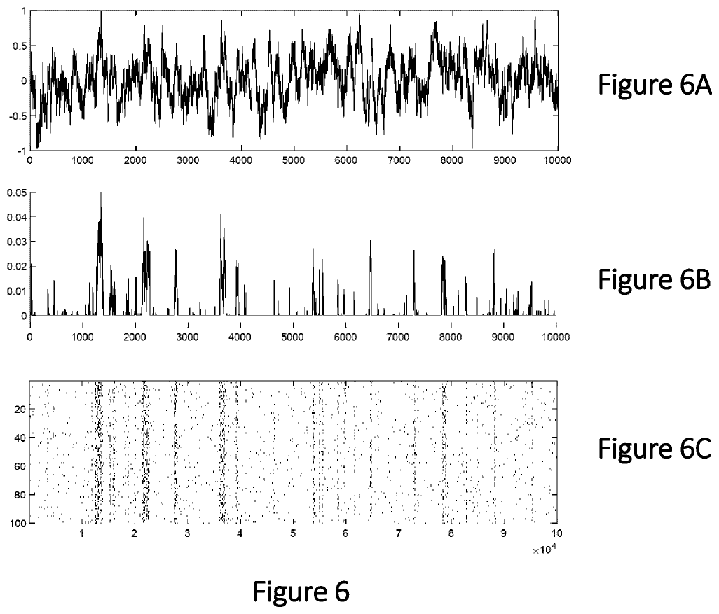

FIGS. 6A-6C shows an example of spiking neural network response to a (parameterized) input signal after feature-centric pre-processing. FIG. 6A shows a segment of the analog input signal varying over time, with time plotted on the horizontal axis and signal amplitude on vertical axis. FIG. 6B shows the input signal of FIG. 6A after pre-processing and feature extraction. The horizontal axis shows time. The vertical axis shows the amplitude of the postprocessed (rectified, calibrated and sparsened) input to a spiking neural network, comprising e.g. 100 neurons.

FIG. 6C shows the spike response after applying the feature extraction, i.e. the spike response of the spiking neural network to which the postprocessed input signal was an input. The horizontal axis shows time, while the vertical axis represents each individual neuron of the spiking neural network. As one can see, the spike response of the spiking neural network are sparse and distributed around apparent features of interest, more so than without an analog-to-(quantity-of-)information converter and feature filtering, i.e. after feature-centric pre-processing. By having sampled the input signal at its relevant information/feature rate through the extraction of a specific set of features, the signal processing focusses exclusively, or almost exclusively, on feature-bearing information and discard irrelevant information as early in the signal processing path as possible, while filtering out/suppressing other irrelevant information or distorting interferers. By discarding irrelevant information early in the signal processing path, overall system energy-efficiency is significantly improved, since neurons do not spike for the processing of irrelevant information.

Note that features of any of the embodiments disclosed herein may be combined in an appropriate manner.

1. A signal processing circuit for a spiking neural network, comprising an interface for converting an analog input signal to a corresponding spike-time representation of the analog input signal, the interface comprising:
an analog-to-information converter, which comprises an input for receiving the analog input signal and is configured to produce a modulated signal which represents one or more features of the analog input signal;
a feature detector circuit, which comprises an input for receiving the modulated signal and is configured to compare the modulated signal with a reference signal representing a reference feature, and configured to produce an error signal indicating a difference between the modulated signal and the reference signal;
a feature extractor circuit, which comprises a locked loop circuit having an input for receiving the error signal and configured to produce an output signal representing an occurrence of one or more of the features represented by the modulated signal; and
an encoder circuit, which has an input for receiving the output signal of the feature extractor and is configured to encode the output signal into spike trains for input to the spiking neural network.

2. The signal processing circuit of claim 1, further comprising a preprocessing circuit that preprocesses the analog input signal.

3. The signal processing circuit of claim 1, wherein the analog input signal is in voltage representation and is used as control voltage input to the analog-to-information converter, thus determining the modulation of the analog input signal.

4. The signal processing circuit of claim 1, wherein the one or more features comprise one or more of i) specific characteristics, comprising transient features and/or steady-state features, ii) specific properties, comprising linearity features, non-linearity features, statistical features, stationary features, transfer-function features, and/or energy-content, and/or based on iii) specific domain features comprising time-, delay-, frequency-, and/or phase-domain features.

5. The signal processing circuit of claim 1, wherein the analog-to-information converter forms an analog-to-delay converter, an analog-to-frequency converter, and/or an analog-to-phase converter.

6. The signal processing circuit of claim 1, wherein the output signal of the feature extractor circuit is fed back to the feature detector circuit to form a negative feedback loop.

7. The signal processing circuit of claim 1, wherein the feature extractor circuit comprises a voltage-controlled oscillator which is driven by the error signal and which creates the output signal of the feature extractor circuit and is part of the locked loop circuit.

8. The signal processing circuit of claim 1, wherein the locked loop circuit comprises a delay-locked loop, a frequency-locked loop or a phase-locked loop.

9. The signal processing circuit of claim 1, wherein the feature extractor circuit furthermore comprises a filter, filter, that stops part of the error signal if it is not in a locking range of the locked loop circuit, but that lets through part of the error signal which is in the locking range of the locked loop circuit.

10. The signal processing circuit of claim 1 wherein the encoder circuit uses rate-based or temporal, spike-based encoding as the encoding scheme.

11. The signal processing circuit of claim 1, wherein the feature extractor circuit comprises part of a set of parallel feature extractors circuits, and wherein the signal processing circuit furthermore comprises a channel selector unit which is adaptive in such a way that a subset of features most beneficial under specific operating conditions at any given moment in time are being extracted, so that the one or more feature extractor circuits corresponding to the subset of features of interest can be adaptively selected, and information on those features are extracted from the signal from the analog-to-information converter by the parallel feature extractor circuits.

12. The signal processing circuit of claim 1, wherein feature extraction performed by the feature extractor circuit is configurable by means of circuit parameters and/or system control parameters, wherein the parameters include one or more of gain, linearity, bandwidth, feed-forward and feed-back, coarse/fine selectivity, ATC control, feedback control, calibration, timing, delay, sampling/sub-sampling mode selection.

13. The signal processing circuit of claim 1, wherein at run time, an application/context/condition detection block determines the current operating context and from the current operating context determines the optimal analog feature set to be extracted.

14. The signal processing circuit of claim 1, wherein the analog input signal comprises an analog differential voltage signal, with a positive and negative voltage input.

15. The signal processing circuit of claim 1, comprising multiple feature signal paths each for a modulated signal which represents a particular one or more features of the analog input signal, wherein at least one feature signal path comprises a programmable fabric, which provides control feedback to at least one other feature signal path based on the output of the programmable fabric.

16. The signal processing circuit of claim 1, further comprising a convertor unit which converts the modulated signal or the error signal to a digital signal.

17. A signal processing method for converting an analog input signal to a corresponding spike-time representation of the analog input signal for a spiking neural network, the method comprising:
receiving the analog input signal;
producing a modulated signal which represents one or more features of the analog input signal;
comparing the modulated signal with a reference signal representing a reference feature
producing an error signal indicating a difference between the modulated signal and the reference signal;
producing an output signal representing an occurrence of one or more of the features represented by the modulated signal; and
encoding the output signal into spike trains for input to the spiking neural network.

18. The signal processing method of claim 17, wherein the one or more features comprise ne or more of i) specific characteristics, comprising transient feature and/or steady-state features, ii) specific properties, comprising linearity features, non-linearity features, statistical features, stationary features, transfer-function features, and/or energy-content and/or based on iii) specific domain features, comprising time-, delay-, frequency-, and/or phase-domain features.
